(19) United States
(12) Patent Application Publication
(10) Pub. No.: US 2026/0036978 A1
(43) Pub. Date: Feb. 5, 2026

(54) INFORMATION PROCESSING METHOD, SUBSTRATE PROCESSING SYSTEM, AND COMPUTER-READABLE RECORDING MEDIUM

(71) Applicant: Tokyo Electron Limited, Tokyo (JP)

(72) Inventors: Wataru FUNAKOSHI, Koshi City (JP); Takafumi KUROKI, Koshi City (JP); Takayuki MASAKI, Koshi City (JP); Kiminari SAKAGUCHI, Koshi City (JP); Hirofumi ETOU, Koshi City (JP); Yasuhiro KITADA, Sapporo City (JP); Kouji OKAMURA, Koshi City (JP)

(21) Appl. No.: 19/288,114

(22) Filed: Aug. 1, 2025

(30) Foreign Application Priority Data
Aug. 2, 2024 (JP) 2024-128078

(51) Int. Cl. G05B 23/02; G06F 3/0482; G06F 3/0484; G06F 8/61; G06F 8/65

(52) U.S. Cl. CPC G05B 23/0283; G06F 8/61; G06F 8/65; G06F 3/0482; G06F 3/0484

(57) ABSTRACT

An information processing method includes: when a terminal device is connected to a first interface of a plurality of interfaces dispersedly arranged in a substrate processing apparatus including a plurality of modules, displaying, on the terminal device, modules which are capable of being instructed to operate by the terminal device, among the plurality of modules, according to the first interface to which the terminal device is connected; selecting a module to be subjected to a maintenance among the modules displayed on the terminal device, and receiving the selection of the module to be subjected to the maintenance among the modules displayed on the terminal device; and outputting a maintenance instruction relating to the maintenance on the selected module.

### CROSS-REFERENCE TO RELATED APPLICATION

This application is based upon and claims the benefit of priority from Japanese Patent Application No. 2024-128078, filed on Aug. 2, 2024, the entire contents of which are incorporated herein by reference.

### TECHNICAL FIELD

The present disclosure relates to an information processing method, a substrate processing system, and a non-transitory computer-readable recording medium storing a computer program.

### BACKGROUND

A substrate processing apparatus, which performs substrate processing such as etching or film formation on a substrate such as a semiconductor wafer or a glass substrate, includes a plurality of modules that perform operations for the substrate processing, a display that displays information thereon, and an operation unit that receives operations. Information for controlling each module is displayed on the display. Each module is controlled according to the operations received by the operation unit. Patent Document 1 discloses a substrate processing apparatus that uses a remote operation terminal for receiving operations via a communication network.

### PRIOR ART DOCUMENTS

### Patent Documents

[Patent Document 1] Japanese Laid-Open Patent Publication No. 2022-041233

Modules included in the substrate processing apparatus may be subjected to maintenance such as cleaning. Maintenance capacity may be improved by displaying information about maintenance and receiving operations relating to the maintenance using a readily-portable terminal device, the maintenance capacity can be improved. However, when the terminal device is used to control the maintenance of each module, safety may be reduced. For example, when a module that is invisible by eyes of a user who uses the terminal device is subjected to the maintenance, safety may not be ensured.

### SUMMARY

According to one embodiment of the present disclosure, an information processing method includes: when a terminal device is connected to a first interface of a plurality of interfaces dispersedly arranged in a substrate processing apparatus including a plurality of modules, displaying, on the terminal device, modules which are capable of being instructed to operate by the terminal device, among the plurality of modules, according to the first interface to which the terminal device is connected; selecting a module to be subjected to a maintenance among the modules displayed on the terminal device, and receiving, at the terminal device, the selection of the module to be subjected to the maintenance among the modules displayed on the terminal device; and outputting a maintenance instruction relating to the maintenance on the selected module.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a conceptual view showing an example of a configuration of a substrate processing system.

FIG. 2 is a schematic block diagram showing an example of an internal configuration of a substrate processing apparatus.

FIG. 3 is a block diagram showing an example of an internal configuration of a terminal device.

FIG. 4 is a block diagram showing an example of internal configurations of a controller and an operation panel.

FIG. 5 is a conceptual diagram showing an example of contents of restriction information.

FIG. 6 is a flowchart showing an example of a processing procedure performed when the terminal device is connected to an interface.

FIG. 7 is a schematic view showing an example of a block diagram of a plurality of modules and a list of a plurality of modules.

FIG. 8 is a flowchart showing an example of a processing procedure for performing a maintenance of each module included in the substrate processing apparatus using the terminal device.

FIG. 9 is a schematic view showing an example of contents displayed by the terminal device when selecting a module and receiving the contents of maintenance of the module.

FIG. 10 is a schematic view showing an example of display of states of modules to be maintained, the contents of maintenance, and the current number of repetitions of the maintenance.

FIG. 11 is a flowchart showing an example of a processing procedure for handling an alert in each module included in the substrate processing apparatus.

FIG. 12 is a schematic view showing an example of a highlighted module corresponding to the alert and a highlighted parameter corresponding to the alert.

FIG. 13 is a flowchart showing an example of a processing procedure for preventing data from being transferred to the outside or from being held in a terminal device.

### DETAILED DESCRIPTION

Hereinafter, the present disclosure will be described in detail below with reference to the drawings showing embodiments thereof. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

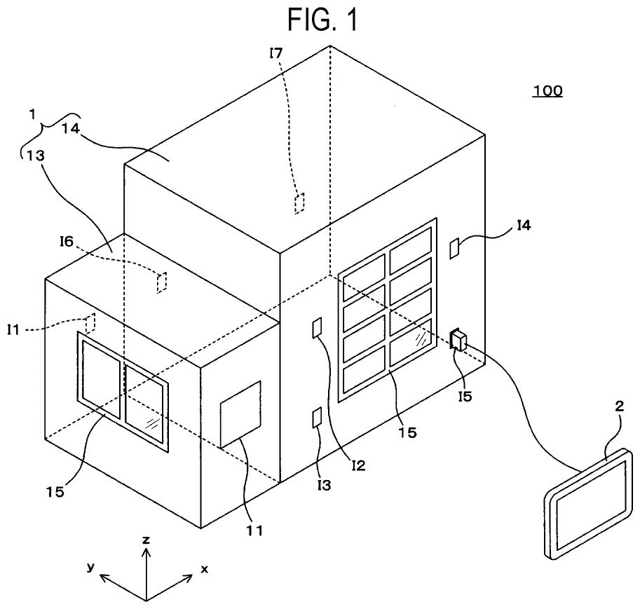

FIG. 1 is a conceptual view showing an example of a configuration of a substrate processing system 100. The substrate processing system 100 includes a substrate processing apparatus 1 and a terminal device 2. For example, the substrate processing apparatus 1 is an apparatus that applies a resist to a semiconductor wafer, which is a substrate, and performs development. The terminal device 2 is connected to the substrate processing apparatus 1 and performs display of information and reception of instructions, which are relating to a control of the substrate processing apparatus 1. In particular, the terminal device 2 performs display of information and reception of instructions, which are relating to maintenance. The substrate processing apparatus 1 includes a plurality of blocks. In an example shown in FIG. 1, the substrate processing apparatus 1 includes a carrier station block 13 and a process block 14.

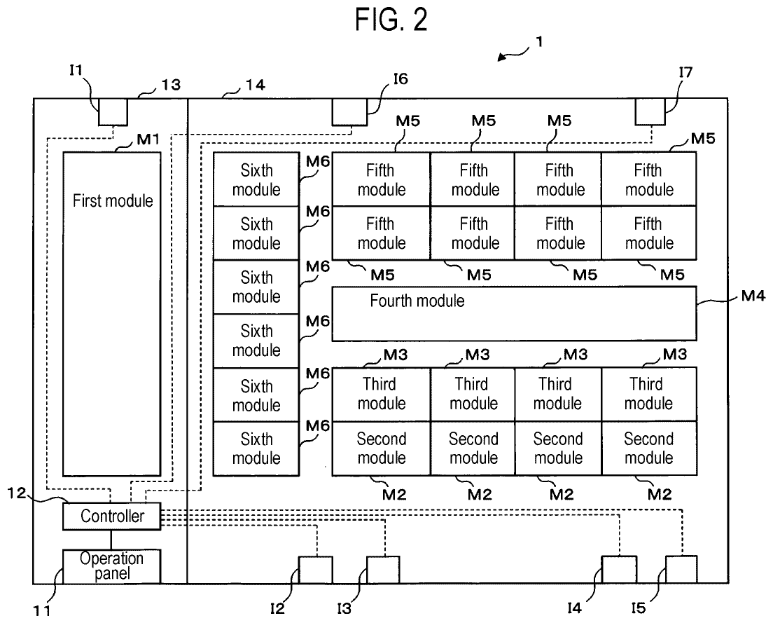

FIG. 2 is a schematic block diagram showing an example of an internal configuration of the substrate processing apparatus 1. The substrate processing apparatus 1 includes a plurality of modules, each of which performs an operation for substrate processing. The plurality of modules included in the substrate processing apparatus 1 include a plurality of types of modules, or a plurality of modules of the same type. FIG. 2 shows an example in which a first module M1, a plurality of second modules M2, a plurality of third modules M3, a fourth module M4, a plurality of fifth modules M5, and a plurality of sixth modules M6 are included in the substrate processing apparatus 1.

For example, the first module M1 is a module that loads a cassette storing a plurality of substrates thereinto. For example, each second module M2 is a module that applies a resist to a semiconductor wafer, which is a substrate. For example, each third module M3 is a module that performs development. For example, the fourth module M4 is a module that transfers the substrate. For example, each fifth module M5 is a module that performs heat treatment on the substrate.

The first module MI is included in the carrier station block 13. The second modules M2, the third modules M3, the fourth module M4, and the fifth modules M5 are included in the process block 14. The second modules M2 and the third modules M3 are stacked one above another in the vertical direction, that is, the z-axis direction shown in FIG. 1. The fifth modules M5 are also stacked one above another in the z-axis direction. The fourth module M4 is appropriately provided between the second modules M2, the third modules M3, and the fifth modules M5. In addition, the sixth modules M6 are included in the process block 14 and is provided between the first module M1, the second modules M2, the third modules M3, the fourth module M4, and the fifth modules M5. For example, each sixth module M6 is a module that places the substrate delivered between the carrier station block 13 and the process block 14 thereon, or a module that adjusts a temperature of the substrate. The sixth module M6 is stacked one above another in the z-axis direction or arranged side by side in the y-axis direction.

The substrate processing apparatus 1 includes a fixed operation panel 11 and a controller 12. The operation panel 11 performs display of information and reception of instructions relating to the control of the substrate processing apparatus 1. The operation panel 11 corresponds to a reception device. The controller 12 controls operations of individual modules included in the substrate processing apparatus 1. The operation panel 11 is connected to the controller 12. The controller 12 controls the operation of each module according to instructions received through the operation panel 11. In particular, the controller 12 controls a maintenance process in each module according to the instructions received through the operation panel 11. Windows 15 are provided at a plurality of locations in the substrate processing apparatus 1. A user may observe an interior of the substrate processing apparatus 1 via the windows 15 to check each module.

The substrate processing apparatus 1 includes a plurality of interfaces to which the terminal device 2 may be connected. For example, each interface is a universal serial bus (USB). FIG. 2 shows an example in which the substrate processing apparatus 1 includes a first interface I1, a second interface I2, a third interface I3, a fourth interface I4, a fifth interface I5, a sixth interface I6, and a seventh interface I7. The plurality of interfaces are dispersedly arranged at various locations in the substrate processing apparatus 1. The first interface I1 is disposed at a position on a rear side of the operation panel 11. In the example shown in FIG. 1, the operation panel 11 is disposed on an xz plane of the substrate processing apparatus 1, and the first interface I1 is disposed on the rear side of the operation panel 11 in the y-axis direction.

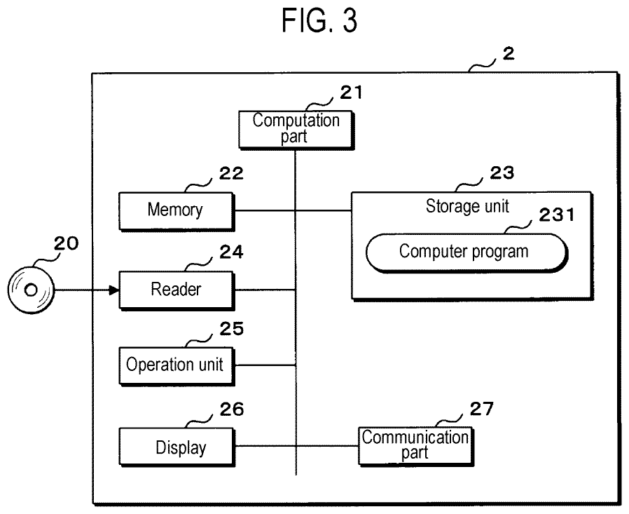

FIG. 3 is a block diagram showing an example of an internal configuration of the terminal device 2. The terminal device 2 is constituted with a computer such as a tablet computer or a notebook computer. The terminal device 2 is portable for a user. The terminal device 2 includes a computation part 21, a memory 22, a storage 23, a reader 24, an operation unit 25, a display 26, and a communication part 27. The computation part 21 is constituted with, for example, a central processing unit (CPU), a graphics processing unit (GPU), or a multi-core CPU. The computation part 21 may be constituted with a quantum computer. The computation part 21 may be one or more circuits. The memory 22 stores temporary data generated in association with computation. The memory 22 may be, for example, a random access memory (RAM). The storage 23 is non-volatile and may be, for example, a hard disk or a non-volatile semiconductor memory, or a combination of a hard disk and a non-volatile memory. The reader 24 reads information from a recording medium 20 such as an optical disc or a portable memory.

The operation unit 25 receives input of information such as a text, which corresponds to an operation made by the user. The operation unit 25 is, for example, a keyboard, a pointing device, or a touch panel. The display 26 displays an image thereon. The display 26 is, for example, a liquid crystal display or an electroluminescent display (EL) display. The operation unit 25 and the display 26 may be integrated together. The communication part 27 communicates with the outside of the terminal device 2. More specifically, the communication part 27 is connected to any one of the first interface I1 to the seventh interface I7 via a signal line, and communicates with the controller 12 via that interface. In this embodiment, the communication part 27 performs communication using any one of the first interface I1 to the seventh interface I7 in a wired communication. Note that the communication part 27 may be configured to communicate using short-range wireless communication such as Bluetooth (registered trademark).

The computation part 21 causes the reader 24 to read a computer program (program product) 231 recorded in the recording medium 20, and cause the storage 23 to store the read computer program 231. The computation part 21 executes a process to implement functions of the terminal device 2 according to the computer program 231. The computer program 231 may be stored in the storage 23 in advance, or may be downloaded from the outside of the terminal device 2. In this case, the terminal device 2 does not need to include the reader 24.

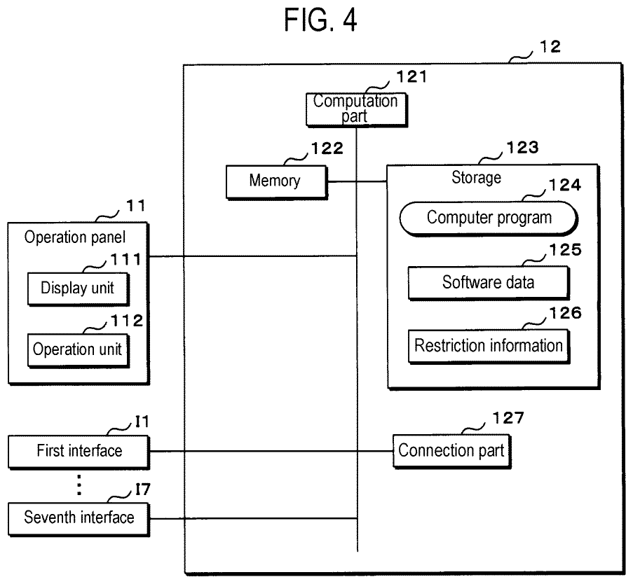

FIG. 4 is a block diagram showing an example of internal configurations of the controller 12 and the operation panel 11. The controller 12 is constituted with a computer. The controller 12 includes a computation part 121, a memory 122, a storage 123, and a connection part 127. The computation part 121 is constituted with, for example, a CPU, a GPU, or a multi-core CPU. The computation part 121 may be constituted with a quantum computer. The computation part 121 may be one or more circuits. The memory 122 stores temporary data generated in association with computation. The memory 122 may be, for example, a RAM. The storage 123 is non-volatile and may be, for example, a hard disk or a non-volatile semiconductor memory, or may be a combination of a hard disk and a non-volatile memory.

The storage 123 stores a computer program 124. The computation part 121 executes a process to implement functions of the controller 12 according to the computer program 124. The connection part 127 is connected to each module included in the substrate processing apparatus 1. The connection part 127 transmits, to each module, a control signal for controlling the operation of each module. The connection part 127 also receives, from each module, information indicating a state of each module.

The operation panel 11 is connected to the controller 12. The operation panel 11 includes a display 111 and an operation unit 112. The display 111 is, for example, a liquid crystal display or an EL display. The display 111 displays information relating to the control of the substrate processing apparatus 1. The operation unit 112 is, for example, a keyboard, a pointing device, or a touch panel. The operation unit 112 receives instructions for controlling the substrate processing apparatus 1, which is made by the user.

Further, the first interface I1, the second interfaces I2, the third interfaces I3, the fourth interface I4, the fifth interfaces I5, the sixth interfaces I6, and the seventh interfaces I7 are connected to the controller 12. The computation part 121 communicates with the terminal device 2 via an interface to which the terminal device 2 is connected. The computation part 121 transmits the information relating to the control of the substrate processing apparatus 1 to the terminal device 2 via the interface, and the terminal device 2 displays the received information about the display 26. The controller 12 may be disposed outside the substrate processing apparatus 1. In this embodiment, the controller 12 is connected to the substrate processing apparatus 1 via a signal line.

When the user operates the operation unit 25, the terminal device 2 receives instructions for controlling the substrate processing apparatus 1 and transmits the received instructions to the controller 12 via the interface. The controller 12 receives the instructions transmitted from the terminal device 2, and the computation part 121 controls each module according to the received instructions. In particular, the controller 12 causes the terminal device 2 to display maintenance-related information in each module, the terminal device 2 receives instructions relating to the maintenance, and the controller 12 controls a maintenance process in each module according to the received instructions.

The storage 123 stores software data 125 required for installing, in the terminal device 2, software used by the terminal device 2 to perform the display of the information and the reception of the instructions relating to the control of the substrate processing apparatus 1. The software installed using the software data 125 is a part or all of the computer program 231, and is data used by the computer program 231.

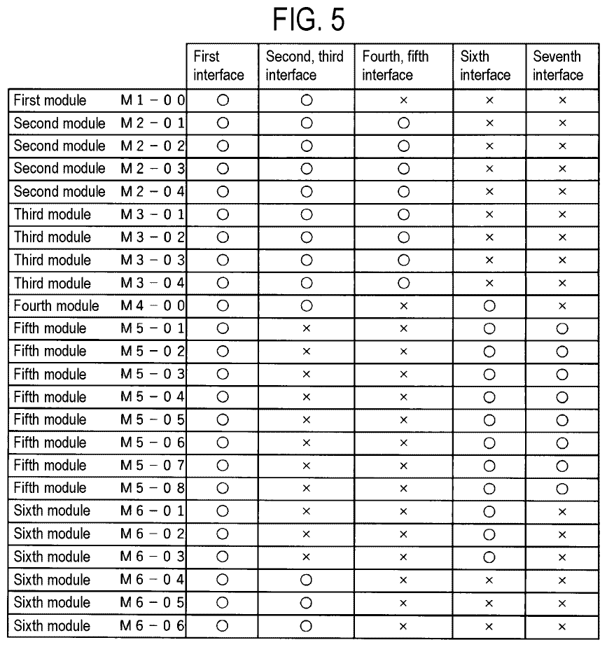

The operation panel 11 may receive instructions to control all of the modules. The controller 12 controls all of the modules according to the instructions received by the operation panel 11. The controller 12 also restricts the modules which are capable of being controlled using the terminal device 2 according to an interface to which the terminal device 2 is connected. The storage 123 stores restriction information 126 that defines whether or not each module may be controlled. FIG. 5 is a conceptual diagram showing an example of the contents of the restriction information 126. FIG. 5 shows module names and module identification numbers. A plurality of modules of the same type are distinguished from each other by their identification numbers.

FIG. 5 shows interface names. An O mark or an X mark is associated with the module name/identification number and the interface name. The O mark indicates that a module associated with the name and the identification number may be controlled using the terminal device 2 connected to an interface associated with the name. The X mark indicates that a module associated with the name and the identification number cannot be controlled using the terminal device 2 connected to an interface associated with the name.

In the example shown in FIG. 5, all of the modules may be controlled using the terminal device 2 connected to the first interface I1. That is, the terminal device 2 receives instructions for controlling all of the modules. Therefore, the terminal device 2 connected to the first interface I1 may receive a plurality of instructions that are the same as the plurality of instructions for controlling the substrate processing apparatus, which may be received by the operation panel 111. The user may use the terminal device 2 connected to the first interface I1 to perform the same operations as when using the operation panel 11. As shown in FIG. 1, the first interface I1 is disposed at a position on the rear side of the operation panel 11 in the y-axis direction. Even when the user is positioned on the rear side of the operation panel 11, the user may use the terminal device 2 to perform the same operations as when using the operation panel 11.

In the example shown in FIG. 5, using the terminal device 2 connected to the second interface I2 and the third interface I3, the first, second, third, and fourth modules may be controlled, but the fifth module cannot be controlled. Some of the sixth modules may be controlled, but the other sixth modules may not be controlled. Using the terminal device 2 connected to the fourth interface I4 and the fifth interface I5, the second and third modules may be controlled, but the first, fourth, fifth, and sixth modules may not be controlled. Using the terminal device 2 connected to the sixth interface I6, the fourth and fifth modules may be controlled, but the first, second, and third modules may not be controlled. Some of the sixth module may be controlled, but the other sixth modules may not be controlled. Using the terminal device 2 connected to the seventh interface I7, the fifth modules may be controlled, but the first, second, third, fourth, and sixth modules may not be controlled.

For example, the restrictions on modules which are capable of being controlled using the terminal device 2 connected to interfaces other than the first interface I1 are determined according to a positional relationship between the interface and the module. A module, an operation of which is visible at a position of the user using the terminal device 2 connected to each interface, may be controlled. A module, an operation of which is invisible at the position of the user, may not be controlled.

For example, when the user uses the terminal device 2 connected to the second interface 12 and the third interface I3, he/she may visually observe the operations of the first, second, third, and fourth modules via the windows 15. The fifth module is disposed on the rear side of the second, third, and fourth modules in the y-axis direction. As seen from the user in the vicinity of the second interface I2 and the third interface I3, the fifth module is located behind the second, third, and fourth modules. Therefore, the user cannot see the fifth module and cannot visually observe the operation of the fifth module. Further, the user may visually observe, via the window 15, the operations of sixth modules, which are located close to the second interface I2 and the third interface I3 in the y-axis direction, among the plurality of sixth modules. Sixth modules that are located far from the second interface I2 and the third interface I3 in the y-axis direction are located behind the other modules as seen from the user, and the user cannot visually observe the operations of these sixth modules.

In this way, the user may control the modules whose operations are visible to his/her eyes, using the terminal device 2 connected to the second interface I2 and the third interface I3. Further, the user may not control the modules whose operations are invisible to his/her eyes, using the terminal device 2 connected to the second interface I2 and the third interface I3. Similarly, for the other interfaces, the user may control another module whose operation is visible to his/her eyes, using the terminal device 2 connected to respective interfaces, but may not control another module whose operation is invisible to his/her eyes, using the terminal device 2 connected to the respective interfaces.

When the user operates a module whose operation is invisible to his/her eyes, he/she may be less likely to immediately check that a malfunction occurs in that module. By controlling a module whose operation is visible at the position of the user and not controlling other modules, the user may quickly check the occurrence of malfunction, which ensures the safety of the substrate processing apparatus 1. In addition, even if the operation of the module is invisible by the user, the user may control the module using the terminal device 2 connected to the interface. In this case, the restriction information 126 may be provided to control the module whose operation is invisible by the user.

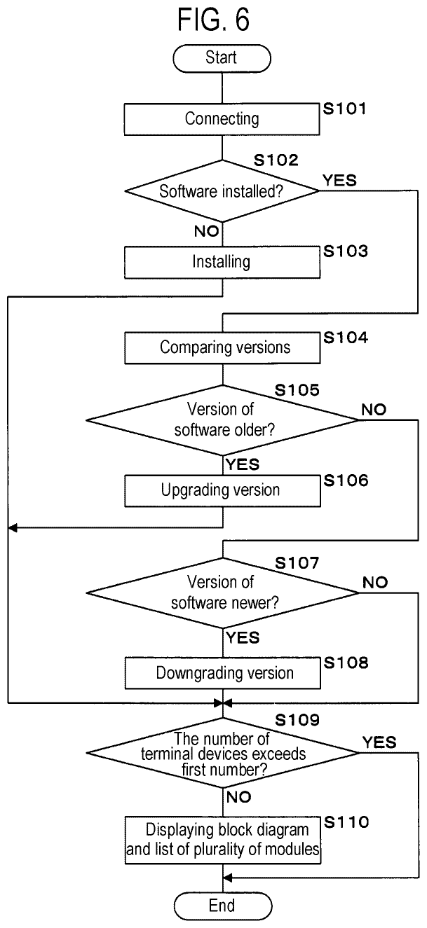

The operation of the substrate processing system 100 will be described. The substrate processing system 100 executes an information processing method. FIG. 6 is a flowchart showing an example of a processing procedure performed when the terminal device 2 is connected to the interface. Hereinafter, an operation will be referred to as Operation S. When the computation part 121 executes information processing according to the computer program 124, the controller 12 executes the following processes. In addition, when the computation part 21 executes information processing according to the computer program 231, the terminal device 2 executes the following processes.

The terminal device 2 is connected to one of the interfaces (Operation S101). At this time, the terminal device 2 may execute a log-in process. In a case in which software for executing display of information and reception of instructions relating to the control of the substrate processing apparatus 1 is not installed in the terminal device 2 connected to the interface (NO in Operation S102), the controller 12 and the terminal device 2 install the software therein (Operation S103). The user determines whether or not the software is installed in the terminal device 2. When the software is determined to not be installed, the user operates the operation unit 25 to input an instruction to install the software. The terminal device 2 or the controller 12 may perform a process of determining whether or not the software is installed in the terminal device 2.

In Operation S103, in response to a software installation instruction input by the user, the terminal device 2 downloads the software data 125 from the controller 12. The computation part 21 uses the software data 125 to install the software. At this time, a part or all of the computer program 231 may be updated. In Operation S103, the software data 125 may be downloaded from the outside of the substrate processing apparatus 1 and installed in the substrate processing apparatus 1 via a communication network. In Operation S103, the installation may be performed automatically without an instruction from the user, or the controller 12 may install the software in the terminal device 2. Once the process of Operation S103 is completed, a process of Operation S109 to be described later is executed.

When the software is determined to be installed (YES in Operation S102), the terminal device 2 compares a version of the software required to perform the display of information and the reception of instructions relating to the control of the substrate processing apparatus 1 with a version of software which has been installed in the terminal device 2 (Operation S104). The software required to perform the display of information and the reception of instructions relating to the control of the substrate processing apparatus 1 refers to to a first software. The software which has been installed in the terminal device 2 refers to a second software. The controller 12 stores the version of the software required to control the substrate processing apparatus 1. In Operation S104, the computation part 21 acquires the version of the software required to control the substrate processing apparatus 1 from the controller 12, and compares the version of the software required to control the substrate processing apparatus 1 with the version of the software which has been installed in the terminal device 2. The comparison of the versions of the software may be performed by the controller 12. The terminal device 2 determines whether or not the version of the software which has been installed in the terminal device 2 is older than the version of the software required to control the substrate processing apparatus 1 (Operation S105). The operation of determining such a software version may be performed by the controller 12.

When the version of the software which has been installed in the terminal device 2 is determined to be older (YES in Operation S105), the terminal device 2 upgrades the version of the installed software (Operation S106). In Operation S106, the computation part 21 downloads the software data 125 from the controller 12 and installs the software using the software data 125. Thus, the version of the software which has been installed in the terminal device 2 is upgraded to the version of the software required to control the substrate processing apparatus 1. The upgrade of the software version may be performed by the controller 12. Once the process of Operation S106 is completed, the process of Operation S109 to be described later is executed.

When the version of the software which has been installed in the terminal device 2 is not older (NO in Operation S105), the terminal device 2 determines whether or not the version of the software which has been installed in the terminal device 2 is newer than the version of the software required to control the substrate processing apparatus 1 (Operation S107). The determination of such a software version may be performed by the controller 12. When the version of the software which has been installed in the terminal device 2 is determined to be newer (YES in Operation S107), the terminal device 2 downgrades the version of the installed software (Operation S108). In Operation S108, the computation part 21 downloads the software data 125 from the controller 12 and installs the software using the software data 125. Thus, the version of the software which has been installed in the terminal device 2 is downgraded to the version of the software required to control the substrate processing apparatus 1. The operation of downgrading the software version may be performed by the controller 12.

By the process of Operation S103, the software required to perform the display of information and the reception of instructions relating to the control of the substrate processing apparatus 1 is installed in the terminal device 2. By the processes of Operations S104 to S108, the version of the software which has been installed in the terminal device 2 is coincided with the version of the software required to perform the display of information and the reception of instructions relating to the control of the substrate processing apparatus 1. By these processes, the terminal device 2 may execute the process of performing the display of information and the reception of instructions relating to the control of the substrate processing apparatus 1.

In order to upgrade the version of the software required to control the substrate processing apparatus 1, the substrate processing apparatus 1 needs to be stopped, which halts the production of substrates. This makes it difficult to upgrade the version of the software. In addition, the upgraded version of the software is not necessarily compatible with all modules included in the substrate processing apparatus 1. Therefore, available versions of the software may differ from each other in the modules included in the substrate processing apparatus 1. As described above, the version of the software required to control the substrate processing apparatus 1 may differ for each apparatus. In this embodiment, the terminal device 2 may flexibly match the version of the software to the substrate processing apparatus 1. Thus, even in a situation where a plurality of substrate processing apparatuses 1 is provided, all of the substrate processing apparatuses 1 may be controlled by the terminal device 2. In addition, even if different types of substrate processing apparatuses 1 are provided, they may be controlled by the terminal device 2.

After the process of Operations S103 and S106, or Operation S108 is completed, or when the version of the software which has been installed in the terminal device 2 is determined to not be newer in Operation S107 (NO in Operation S107), the controller 12 determines whether or not the number of terminal devices 2 connected to a plurality of interfaces exceeds a predetermined first number (Operation S109). The controller 12 stores the predetermined first number in the storage 123 in advance. In Operation S109, the computation part 121 compares the number of terminal devices 2 connected to the plurality of interfaces with the first number stored in the storage 123. For example, the first number is 3.

When the number of terminal devices 2 connected to the plurality of interfaces is determined to exceed the first number (YES in Operation S109), the controller 12 ends the process. This case corresponds to a case where another terminal device 2 is newly connected to the interfaces in a state where the first number of terminal devices 2 are connected to the plurality of interfaces. In this case, the controller 12 disables the terminal device 2 from executing Operation S110 (to be described later) required for selecting a module to be subjected to a maintenance. Thus, the controller 12 disables the terminal device 2 newly connected to the interface from receiving the selection of the module to be subjected to maintenance, and disables the terminal device 2 newly connected to the interface from performing a process relating to the maintenance of the module. At this time, the terminal device 2 may display, on the display 26, a message indicating that such a maintenance-related process is impossible. For example, the terminal device 2 may display a message indicating that the maintenance-related process is impossible because the number of terminal devices 2 connected to the plurality of interfaces is large. For example, a message indicating that the number of terminal devices 2 connected to the plurality of interfaces or a position of the interface to which another terminal device 2 is connected, may be displayed. The process of Operation S109 and the process of disabling the terminal device 2 newly connected to the interface from receiving the selection of the module to be subjected to maintenance when the number of terminal devices 2 connected to the plurality of interfaces exceeds the first number, may be executed by the terminal device 2.

When the number of terminal devices 2 connected to the plurality of interfaces is determined not to the first number (NO in Operation S109), the terminal device 2 displays a block diagram of the plurality of modules and a list of the plurality of modules on the display 26 (Operation S110), and the controller 12 ends the process. The controller 12 and the terminal device 2 end the processes of Operations S101 to S110 each time the terminal device 2 is connected to any of the interfaces.

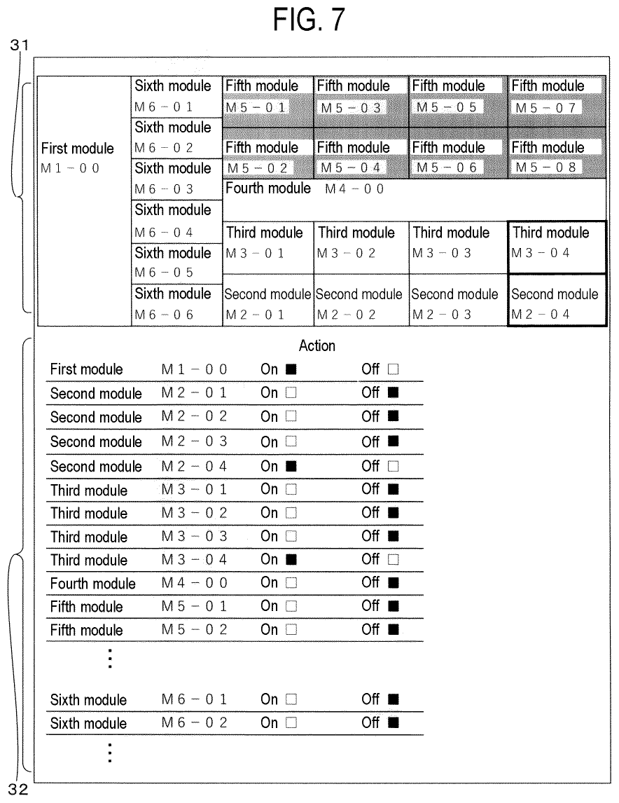

FIG. 7 is a schematic view showing an example of a block diagram 31 of the plurality of modules and a list 32 of the plurality of modules. The block diagram 31 of the plurality of modules is displayed. In the block diagram 31, each module is displayed as a block indicated by the name and identification number of the respective module. In the block diagram 31, the arrangement of each module may be shown. The list 32 of the plurality of modules includes the name and identification number of each module. In the block diagram 31 of the plurality of modules, there are shown modules which are capable of being instructed to operate by the terminal device 2 according to the interface to which the terminal device 2 is connected. More specifically, in the block diagram 31, the terminal device 2 displays the modules which are capable of being instructed to operate by the terminal device 2, on the display 26 in a color different from those of the other modules.

FIG. 7 shows examples of the block diagram 31 of the plurality of modules and the list 32 of the plurality of modules, which are displayed when the terminal device 2 is connected to the second interface I2 or the third interface I3. As shown in FIG. 5, the first module M1, the second module M2, the third module M3, and the fourth module M4 may be controlled using the terminal device 2 connected to the second interface I2 or the third interface I3. The fifth module M5 that may not be controlled using the terminal device 2 is displayed in a gray color, and the first module M1, the second module M2, the third module M3, and the fourth module M4 are displayed in a color different from the gray color.

As described above, the terminal device 2 displays modules which are capable of being controlled using the terminal device 2, that is, modules which are capable of being instructed to operate by the terminal device 2, in a color different from those of modules which are incapable of being instructed to operate by the terminal device 2. In Operation S110, the computation part 21 creates an image of the block of modules with different colors based on the restriction information 126 stored in the storage 123 of the controller 12, and displays the created image on the display 26. By making the colors of the modules different, the user may visually check the contents displayed on the display 26 and may easily recognize the modules which are capable of being instructed to operate by the terminal device 2.

Further, the modules which are capable of being instructed to operate by the terminal device 2 and the modules which are incapable of being instructed to operate by the terminal device 2 may be distinguished from each other in a manner other than the different colors. For example, the modules may be distinguished from each other by blinking the modules which are capable of being instructed to operate by the terminal device 2, or by not displaying the modules which are incapable of being instructed to operate by the terminal device 2. Even in the list 32 of the plurality of modules, the modules which are capable of being instructed to operate by the terminal device 2 and the modules which are incapable of being instructed to operate by the terminal device 2 may be distinguished from each other.

In addition, when displaying the block diagram 31 of the plurality of modules as shown in FIG. 7, a module which is operating according to an instruction different from the instruction issued from the terminal device 2 may be displayed as one which is incapable of being instructed to operate by the terminal device 2. For example, the terminal device 2 displays a module which is operating according to an instruction issued from another terminal device connected to the interface, or a module which is operating according to an instruction issued from the operation panel 11 in a form surrounded by a thick frame. In the example shown in FIG. 7, a second module M2-04 and a third module M3-04 are displayed in the form surrounded by the thick frame. In Operation S110, the computation part 21 acquires, from the controller 12, information about the module which is operating according to the instruction issued from another terminal device or the operation panel 11, creates an image including a block of the identification information module surrounded by the thick frame, and displays the created image on the display 26.

When a module is displayed in the form surrounded by the thick frame, the module refers to one incapable of being instructed to operate by the terminal device 2. The user may easily recognize the module which is operating according to an instruction different from the instruction from the terminal device 2. Further, the module which is incapable of being instructed to operate by the terminal device 2 may be displayed in a manner other than the manner of surrounding the module by the thick frame. For example, the colors of the displayed modules may be different from each other, or the colors of the frames of the displayed module may be different from each other. When the module is incapable of being instructed to operate by the terminal device 2, a character or a graphic indicating such a situation may be added to the module. In addition, even in the list 32 of the plurality of modules, the module which is operating according to an instruction different from the instruction issued from the terminal device 2 may be displayed as one which is incapable of being instructed to operate by the terminal device 2.

In the list 32 of the plurality of modules, whether or not each module is in a substrate processing executable state is displayed. In the example shown in FIG. 7, either Action-On button or Action-Off button, which is indicated by a solid black image, is displayed in association with respective modules. The Action-On button indicated by the solid black image indicates that the module is in the substrate processing executable state. The Action-Off button indicated by the solid black image indicates that the module is in a substrate processing inexecutable state. Each module is subjected to the maintenance in the substrate processing inexecutable state. In Operation S110, the computation part 21 acquires, from the controller 12, information indicating whether or not each module is in the substrate processing executable state, and based on the acquired information, displays the list 32 of the plurality of modules in which either the Action-on button or the Action-Off button is indicated by the solid black image, on the display 26.

When the Action-on button is indicated by the solid black image, that is, when the module is in the substrate processing executable state, the module may not be subjected to the maintenance. In order to perform the maintenance on the module, the state of the module needs to be changed to the substrate processing inexecutable state. In order to perform the maintenance on the module, the user needs to check the list 32 of the plurality of modules to perform an operation of changing the state of the module. This prevents the maintenance from being unexpectedly performed on the module. Thus, it is possible to prevent the production of the substrates by the substrate processing apparatus 1 from being unintentionally halted due to the start of the maintenance. While the module executes the substrate processing, the terminal device 2 or the controller 12 does not perform the process of indicating the Action-Off button by the solid black image, that is, the process of changing the state of the module to the substrate processing inexecutable state. This prevents the module, which is executing the substrate processing, from being accidentally subjected to the maintenance.

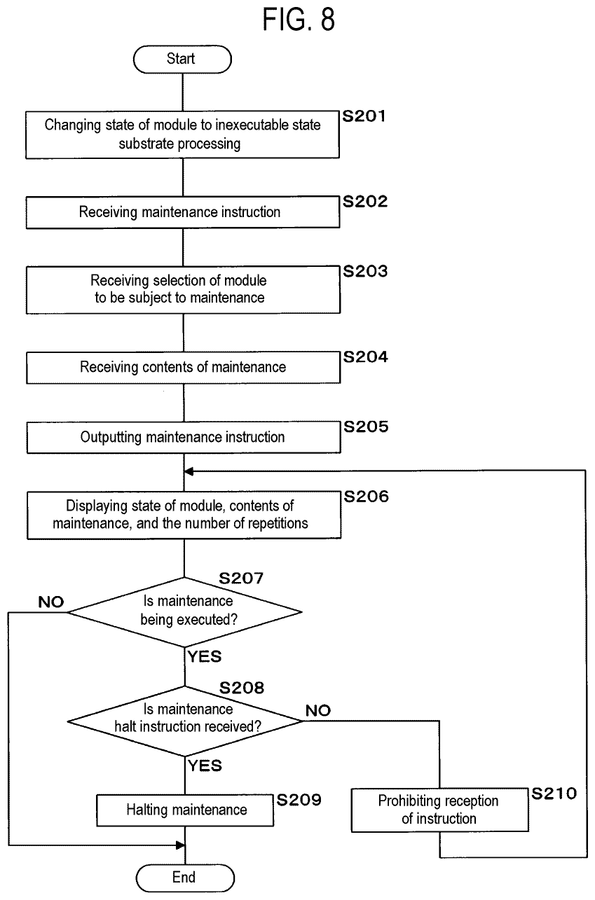

The substrate processing system 100 performs the maintenance on each module. FIG. 8 is a flowchart showing an example of a processing procedure of performing the maintenance on each module included in the substrate processing apparatus 1 using the terminal device 2. The terminal device 2 changes a state of a module to be subjected to maintenance among the plurality of modules included in the substrate processing apparatus 1 to a substrate processing inexecutable state (Operation S201).

In Operation S201, when the user operates the operation unit 25, the terminal device 2 receives an instruction to change the state of the module to be subjected to maintenance to the substrate processing inexecutable state. For example, the user operates the operation unit 25 to input an instruction for the terminal device 2 to indicate, by the solid black image, the Action-Off button associated with the module to be subjected to maintenance in the list 32 of the plurality of modules. The computation part 21 transmits the received instruction to the controller 12. Based on the instruction, the controller 12 changes the state of the module to be subjected to maintenance. The terminal device 2 may receive the instruction to change the states of the plurality of modules, and perform a process of changing the states of the plurality of modules. In a case in which the state of the module to be subjected to maintenance is already in the substrate processing inexecutable state, the process of Operation S201 may be omitted.

When the user operates the operation unit 25, the terminal device 2 receives a maintenance instruction (Operation S202). Subsequently, the terminal device 2 receives the selection of the module to be subjected to maintenance (Operation S203). After receiving the maintenance instruction in Operation S202, in Operation S203, the computation part 21 displays a list of modules in a maintenance enable state on the display 26. When the user operates the operation unit 25, the terminal device 2 receives the selection of the module to be subjected to maintenance in the list. Thereafter, the terminal device 2 receives contents relating to the maintenance to be performed by the module (Operation S204). In Operation S204, when the user operates the operation unit 25, the computation part 21 receives the contents relating to the maintenance.

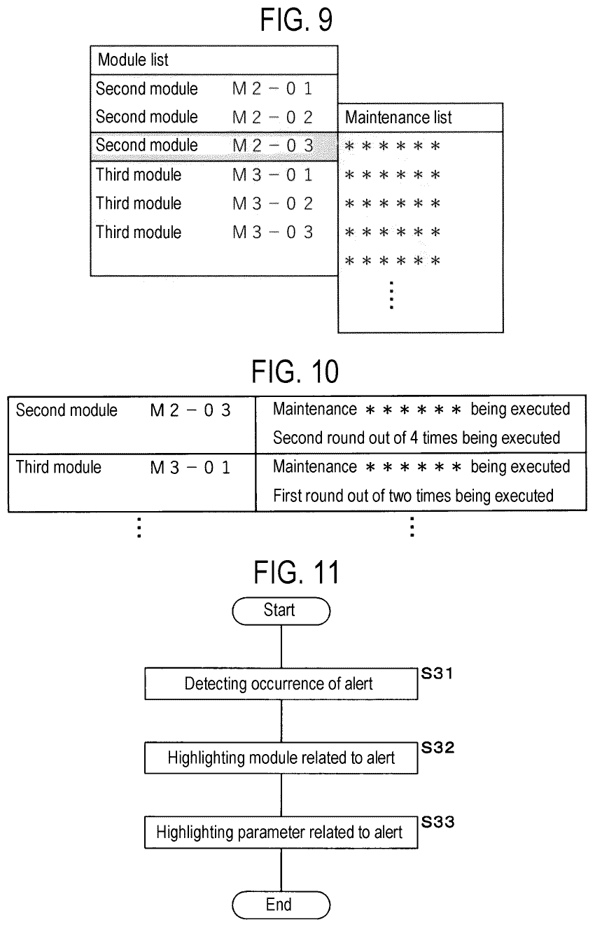

FIG. 9 is a schematic view showing an example of the contents displayed on the terminal device 2 when receiving the selection of the module and the contents relating to the maintenance. In Operation S202, the computation part 21 displays the list of modules in the maintenance enable state on the display 26. The computation part 21 displays a list of modules which are capable of receiving the maintenance instruction from the terminal device 2, on the display 26. At this time, the computation part 21 displays, on the display 26, a list of modules except for the modules which are incapable of being instructed to operate by the terminal device 2 and the modules in the substrate processing executable state. FIG. 9 shows an example in which the second module M2-03 is selected to be subjected to maintenance.

After receiving the selection of the module to be subjected to maintenance in Operation S203, in Operation S204, as shown in FIG. 9, the computation part 21 displays, on the display 26, a list of contents of the maintenance that may be performed on the selected module. For example, the maintenance contents may include purging, cleaning, moving or replacing a specific component in the module with a new one. The user operates the operation unit 25 to select the contents of the maintenance to be executed from the list of the maintenance contents. When the maintenance contents are selected, the computation part 21 receives the maintenance contents. In Operation S204, the terminal device 2 may further receive detailed settings of the maintenance contents.

The terminal device 2 may receive the selection of a plurality of modules to be subjected the maintenance in a parallel manner. In this case, the terminal device 2 executes the processes of Operations S203 to S204 a plurality of times. Each module may be repeatedly subjected to the maintenance a plurality of times. In Operation S204, the terminal device 2 may receive the number of repetitions of maintenances to be repeatedly executed in addition to the maintenance contents. The number of repetitions of maintenances may be determined in advance. By the processes of Operations S202 to S204, the terminal device 2 receives an instruction to execute the maintenance on each module.

Further, in the process of Operation S203, the terminal device 2 is prohibited from receiving the selection of the number of modules to be subjected to maintenance, which exceeds a predetermined second number. For example, the predetermined second number is 4. In Operation S203, the computation part 21 counts the number of modules selected to be subjected to maintenance. When the number of modules thus selected reaches the predetermined second number, the terminal device 2 is prohibited from receiving the selection of the modules to be subjected to maintenance. Thus, the number of modules to be subjected to maintenance by the terminal device 2 is limited. Further, the terminal device 2 may display, on the display 26, a message indicating that the selection of the modules to be subjected to maintenance is impossible. For example, when the number of modules which have been already selected to be subjected to maintenance has reached the second number, the terminal device 2 may display, on the display 26, a message indicating that further selection of modules to be subjected to maintenance is impossible. For example, the message indicating the number of modules which have been already selected to be subjected to maintenance may be displayed on the display 26. The process of preventing the terminal device 2 from receiving the selection of the number of modules to be subjected to maintenance, which exceeds the predetermined second number, may be executed by the controller 12.

Next, the terminal device 2 outputs an instruction to execute the maintenance on the module to be subjected to maintenance (Operation S205). In Operation S205, the computation part 21 transmits, to the controller 12, an instruction to execute the maintenance on the module to be subjected to maintenance as such a maintenance execution instruction. At this time, the computation part 21 transmits information indicating the module to be subjected to maintenance and the maintenance contents to the controller 12. The controller 12 executes the maintenance on the module to be subjected to maintenance. The contents of maintenance to be executed are the same as the maintenance contents received by the terminal device 2. The terminal device 2 transmits the number of repetitions of maintenances to the controller 12. The controller 12 repeatedly executes the maintenance on the module. The controller 12 may repeatedly execute the maintenance on the module a predetermined number of times. The terminal device 2 may output a maintenance instruction to execute the maintenance on the plurality of modules selected to be subjected to maintenance in a parallel manner.

The terminal device 2 displays the state of the module to be subjected to maintenance, the maintenance contents, and a current number of repetitions of maintenances (Operation S206). In Operation S206, the controller 12 transmits the information indicating the state of the module and the current number of repetitions of maintenances to the terminal device 2. The computation part 21 displays the state of the module, the maintenance contents, and the current number of repetitions of maintenances based on the information provided from the controller 12. FIG. 10 is a schematic view showing a display example in which the state of the module to be subjected to maintenance, the maintenance contents, and the current number of repetitions of maintenances are displayed. In FIG. 10, the face that the state of each module is a maintenance execution state, the contents of the maintenance which is being executed, and the current number of repetitions of maintenances are displayed in association with the name of each module.

In Operation S206, the terminal device 2 may display the states of the plurality of modules which are being subjected to maintenance in a parallel manner, the contents of the maintenance which is being executed, and the current number of repetitions of maintenances. FIG. 10 shows an example in which information about the maintenance of the plurality of modules is displayed. By visually checking the displayed contents, the user may check a status of the maintenance on each module, which is being executed in the substrate processing apparatus 1.

The terminal device 2 determines whether or not the maintenance on each module is being executed (Operation S207). In Operation S207, the computation part 21 acquires a status of the module to be subjected to maintenance from the controller 12 to perform a determination. When the maintenance is determined to end and be not in execution (NO in Operation S207), the terminal device 2 ends a current maintenance process. When the maintenance is determined to be in execution (YES in Operation S207), the terminal device 2 determines whether or not an instruction to halt the current maintenance process has been received (Operation S208). When the user operates the operation unit 25 while the maintenance is being executed on the module, an instruction relating to the module which is being subjected to maintenance is input to the terminal device 2. In Operation S208, the computation part 21 determines whether or not the input instruction is an instruction to halt the maintenance.

When the input instruction is determined to be the instruction to halt the maintenance (YES in Operation S208), the terminal device 2 halts the maintenance being executed on the module (Operation S209). In Operation S209, the computation part 21 transmits such a maintenance halt instruction to the controller 12. The controller 12 performs a control to halt the maintenance on the module. After Operation S209 ends, the terminal device 2 ends the maintenance process.

When the maintenance halt instruction is determined not to be received (NO in Operation S208), the terminal device 2 is prohibited from receiving instructions other than the maintenance halt instruction to halt the maintenance on the module (Operation S210). In Operation S210, the computation part 21 prevents the terminal device 2 from receiving the instructions other than the maintenance halt instruction. The terminal device 2 returns the process to Operation S206. By preventing the terminal device 2 from receiving the instructions other than the maintenance halt instruction, each module may be stably subjected to maintenance.

In the substrate processing apparatus 1, a set value for a parameter relating to the state of each module is defined in advance. An alert is issued when the parameter deviates from the set value. Examples of the parameter may include a thickness of a resist applied to the substrate, an amount of resist discharged from a nozzle, a moving speed of a component which moves to be subject to the substrate processing, an amount of air supplied to and exhausted from a module, a temperature of a specific component inside the module, a time taken for the substrate processing in the module, and the like. A value of the parameter is measured in each module.

For example, an upper or lower limit of the parameter is defined as the set value. The alert is generated when the measured value of the parameter exceeds the set value as the upper limit or falls below the set value as the lower limit. The controller 12 stores the set value of the parameter for each module in the storage 123, and generates an alert according to a result obtained by comparing the measured value of the parameter with the set value in each module. For example, when the measured value of the parameter in a module deviates from the set value, the controller 12 generates an alert relating to that module.

FIG. 11 is a flowchart showing an example of a processing procedure of handling an alert in each module included in the substrate processing apparatus 1. The terminal device 2 detects the occurrence of the alert (Operation S31). In Operation S31, the controller 12 transmits the alert to the terminal device 2. The terminal device 2 detects the alert provided from the controller 12. The terminal device 2 highlights a module corresponding to the alert in the list 32 of the plurality of modules displayed on the display 26 (Operation S32). In Operation S32, the computation part 21 creates an image that highlights the module corresponding to the alert provided from the controller 12, and displays the created image on the display 26.

The terminal device 2 highlights and displays a parameter corresponding to the alert on the display 26 (Operation S33). The parameter corresponding to the alert is a specific parameter corresponding to an alert issued when a value deviates from the set value. The computation part 21 acquires the set value and a current value of the specific parameter from the controller 12, and displays the list 32 of the plurality of modules including the acquired parameter values on the display 26. At this time, the computation part 21 highlights and displays the set value and current value of the parameter corresponding to the alert on the display 26. Parameters other than the parameter applied for the issue of the alert may be used as the parameters corresponding to the alert. For example, other parameters applied for the issue of the alert may be stored in the storage 123. When the other parameters applied for the issue of the alert is determined to be the parameter corresponding to the alert, the controller 12 may notify the terminal device 2 of such a determination result.

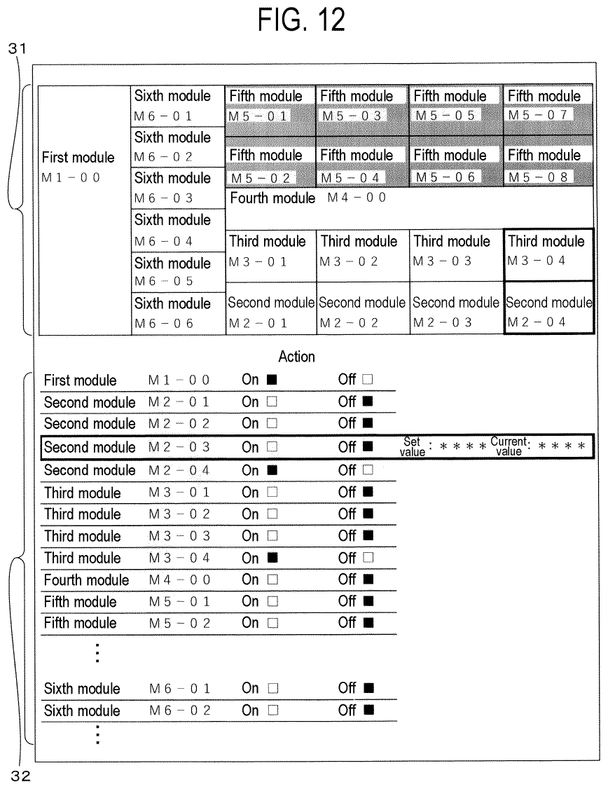

FIG. 12 is a schematic view showing an example in which modules corresponding to the alert and the parameter corresponding to the alert are highlighted. The block diagram 31 of the plurality of modules and the list 32 of the plurality of modules are displayed. In the list 32 of the plurality of modules, the modules corresponding to the alert are highlighted and displayed, and the set value and current value of the parameter are displayed. In FIG. 12, there is shown an example in which the alert is issued for the second module M2-03. The module is highlighted by surrounding the name of the module with a thick frame line. In addition, the set value and current value of the parameter corresponding to the alert are displayed and highlighted by a thick frame line. A pattern other than the thick frame line may be used for the highlighting.

After Operation S33 is completed, the terminal device 2 ends the process of handling the alert. By highlighting the module corresponding to the alert, the user may confirm the module in which the alert has been issued. By highlighting the parameter corresponding to the alert, the user may confirm the parameter corresponding to the alert. For example, the user may determine details of the maintenance on the module to improve the parameter values corresponding to the alert.

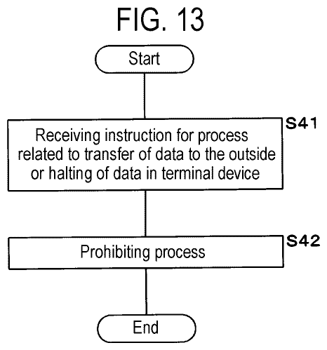

In order to prevent leakage of confidential data relating to the substrate processing apparatus 1, the terminal device 2 executes a process of preventing the data from being outputted outward of the substrate processing system 100 or the data from being held in the terminal device 2. An example of the confidential data may include a recipe indicating the contents of the substrate processing, parameters relating to the state of each module, log data recording processing results in the substrate processing apparatus 1, or the like. FIG. 13 is a flowchart showing an example of a processing procedure of preventing the data from being outputted to outside of the substrate processing system 100 or the data from being held in the terminal device 2. The terminal device 2 receives an instruction to perform a predetermined process relating to the transfer of the data to the outside of the substrate processing system 100 or the holding of the data in the terminal device 2 (Operation S41). In Operation S41, the user operates the operation unit 25 and the computation part 21 receives an instruction to perform the predetermined process.

The process relating to the transfer of the data to the outside is a process that may cause data to be transferred from the terminal device 2 to the outside of the substrate processing system 100. For example, the process relating to the transfer of the data to the outside is a process of transmitting data acquired from the substrate processing apparatus 1 to the outside of the substrate processing system 100 via the communication part 27. For example, the process relating to the transfer of the data to the outside is a process of recording data acquired from the substrate processing apparatus 1 in a portable recording medium such as a non-volatile semiconductor memory. When the process relating to the transfer of the data to the outside is performed, the confidential data relating to the substrate processing apparatus 1 may be leaked.

The process relating to the holding of the data in the terminal device 2 is a process which may cause data relating to the substrate processing apparatus 1 to be held in the terminal device 2. For example, the process relating to the holding of the data in the terminal device 2 is a screenshot. By the screenshot, contents of the data displayed on the display 26 of the terminal device 2 may be held in the terminal device 2. For example, the process relating to the holding of the data in the terminal device 2 is a data export process. By the data export process, the data acquired by the terminal device 2 from the substrate processing apparatus 1 may be held in the terminal device 2. In a case in which the confidential data relating to the substrate processing apparatus 1 is held in the terminal device 2, the confidential data may be leaked from the terminal device 2 after the terminal device 2 is separated from the substrate processing apparatus 1.

The terminal device 2 is prohibited from performing the predetermined process relating to the transfer of the data to the outside or the holding of the data in the terminal device 2 (Operation S42). In Operation S42, the computation part 21 does not execute the process according to the received instruction. A predetermined process that should be prohibited is determined in advance. Information about the predetermined process that should be prohibited is stored in advance in the storage 23 or the storage 123 of the controller 12. In addition to the process relating to the transfer of the data to the outside or the holding of the data in the terminal device 2 which is exemplified herein, other processes that should be prohibited may be displayed. The terminal device 2 may display, on the display 26, other process processes that should be prohibited. The process of Operation S42 may be executed by the controller 12. After Operation S42 is completed, the terminal device 2 ends the process. By prohibiting the process relating to the transfer of the data to the outside or the holding of the data in the terminal device 2, the confidential data relating to the substrate processing apparatus 1 is prevented from being transferred to the outside of the substrate processing system 100 or being held in the terminal device 2. This prevents the confidential data relating to the substrate processing apparatus 1 from being leaked.

As described above, in this embodiment, when the terminal device 2 is connected to one of the plurality of interfaces dispersedly arranged in the substrate processing apparatus 1, the terminal device 2 displays the modules included in the substrate processing apparatus 1. At this time, the terminal device 2 displays modules which are capable of being instructed to operate by the terminal device 2, among the plurality of modules, according to the interface to which the terminal device 2 is connected. The terminal device 2 receives the selection of a module to be subjected to maintenance among the modules which are capable of being instructed to operate by the terminal device 2, and outputs an instruction to execute the maintenance on the selected module. The maintenance on the modules included in the substrate processing apparatus 1 may be controlled using the terminal device 2 which is portable by the user. Compared to a case in which the maintenance is controlled using only the operation panel 11, a degree of freedom of the maintenance may be increased, which improves maintenance capacity.

In this embodiment, the modules which are capable of being instructed to operate by the terminal device 2 are displayed according to the interface to which the terminal device 2 is connected. That is, according to the interface to which the terminal device 2 is connected, modules which may be controlled for maintenance by the terminal device 2 are restricted. The user using the terminal device 2 connected to the interface may see only some of the modules included in the substrate processing apparatus 1. The modules which are visible by the user may see are determined according to a position of the user. The position of the user is determined according to the interface to which the terminal device 2 is connected. Therefore, by restricting the modules which may be controlled for maintenance by the terminal device 2 according to the interface to which the terminal device 2 is connected, it is possible to prevent modules which are invisible by the user from being controlled.

When a malfunction occurs while the maintenance is executed on the module which is invisible by the user, the user may be less likely to immediately check the occurrence of the malfunction. By preventing the user from controlling the module which is invisible with his/her eyes, the user may quickly check the occurrence of malfunction during maintenance.

This ensures the safety of the substrate processing apparatus 1 during maintenance. Therefore, in this embodiment, the maintenance of the substrate processing apparatus 1 using the terminal device 2 may be controlled while ensuring the safety. This improves the maintenance capacity of the substrate processing apparatus 1.

The configuration of the substrate processing apparatus 1 described in this embodiment is merely an example. The substrate processing apparatus 1 may be a coating apparatus, a lithography apparatus, an exposure apparatus, a cleaning apparatus, an etching apparatus, a film forming processing apparatus, an apparatus for bonding or peeling substrates, or the like. According to the present disclosure, it is possible to provide an information processing method, a substrate processing system, and a non-transitory computer-readable recording medium recording a computer program, which are capable of controlling maintenance of a substrate processing apparatus using a terminal device while ensuring the safety of the substrate processing apparatus.

The present disclosure is not limited to the contents of the above-described embodiment, and various modifications may be made within the scope of the claims. In other words, embodiments obtained by combining technical means appropriately modified within the scope of the claims are also included in the technical scope of the present disclosure.

The matters described in each embodiment may be combined with each other. In addition, the independent claims and dependent claims sited in the claims may be combined with each other in all combinations regardless of the citation form. Further, the claims use a format in which a claim cites two or more other claims (multi-claim format), but which is not limited thereto. A format in which a multi-claim cites at least one of other multi-claims (multi-multi-claim) may be employed.

What is claimed is:

1. An information processing method comprising:
when a terminal device is connected to a first interface of a plurality of interfaces dispersedly arranged in a substrate processing apparatus including a plurality of modules, displaying, on the terminal device, modules which are capable of being instructed to operate by the terminal device, among the plurality of modules, according to the first interface to which the terminal device is connected;
selecting a module to be subjected to maintenance among the modules displayed on the terminal device, and receiving, at the terminal device, the selection of the module to be subjected to the maintenance among the modules displayed on the terminal device; and
outputting a maintenance instruction relating to the maintenance on the selected module.

2. The information processing method of claim 1, further comprising:
receiving, at the terminal device, contents relating to the maintenance on the module to be subjected to the maintenance; and
outputting the maintenance instruction according to the received contents.

3. The information processing method of claim 1, further comprising:
selecting the plurality of modules to be subjected to maintenance in a parallel manner, and receiving, at the terminal device, the selection of the plurality of modules to be subjected to the maintenance in a parallel manner; and
outputting the maintenance instruction so as to perform the maintenance on the selected plurality of modules in the parallel manner.

4. The information processing method of claim 3, further comprising:
displaying, on the terminal device, a list of states of the plurality of modules which are being subjected to the maintenance in the parallel manner and contents relating to the maintenance.

5. The information processing method of claim 1, further comprising:
when the selected module is being subjected to the maintenance, preventing the terminal device from receiving an instruction relating to the selected module, other than an instruction to halt the maintenance on the selected module.

6. The information processing method of claim 1, further comprising:
when a portion of the maintenance on the selected module is being performed repeatedly, displaying, on the terminal device, a number of repetitions and a state of the selected module which is being subjected to the maintenance.

7. The information processing method of claim 1, further comprising:
displaying, on the terminal device, the modules which are capable of being instructed to operate by the terminal device, in a color different from those of other modules of the plurality of modules.

8. The information processing method of claim 1, further comprising:
displaying, on the terminal device, an indication that a module, which is operating according to an instruction different from the instruction issued by the terminal device, is incapable of being instructed to operate by the terminal device.

9. The information processing method of claim 1, further comprising:
displaying a list of the plurality of modules on the terminal device; and
receiving an instruction to change a state of any one of the plurality of modules from a substrate processing executable state to a maintenance executable state based on the list of the plurality of modules.

10. The information processing method of claim 1, further comprising:
when a module-related alert is issued, highlighting one module corresponding to the module-related alert in a list of the plurality of modules displayed on the terminal device; and
highlighting and displaying a parameter associated with the module-related alert on the terminal device.

11. The information processing method of claim 1, further comprising:
prohibiting a process relating to a transfer of data to an outside or a holding of the data in the terminal device.

12. The information processing method of claim 1, further comprising:
in a state in which a predetermined first number of terminal devices are connected to a first interface of the plurality of interfaces, when an additional terminal device is connected to the first interface of the plurality of interfaces, prohibiting the additional terminal device from receiving the selection of the module to be subjected to the maintenance; and
prohibiting the terminal device from receiving a selection of a number of modules to be subjected to the maintenance, wherein the number exceeds a predetermined second number.

13. The information processing method of claim 1, further comprising:
when a terminal device is connected to one of the plurality of interfaces, comparing a first version of software required to instruct an operation to one of the plurality of modules included in the substrate processing apparatus with a second version of software which has been installed in the terminal device;
when the second version of software is older than the first version of software, installing the first version of software in the terminal device to upgrade the second version of software which has been installed in the terminal device; and
when the second version of software is newer than the first version of software, installing the first version of software in the terminal device to downgrade the second version of software which has been installed in the terminal device.

14. The information processing method of claim 1, wherein the substrate processing apparatus includes a fixed reception device configured to receive a plurality of instructions for controlling the substrate processing apparatus,
the information processing method further comprising:
when the terminal device is connected to a first interface among the plurality of interfaces, receiving, at the terminal device, a plurality of instructions identical to the plurality of instructions which is capable of being received by the fixed reception device; and
when the terminal device is connected to a second interface different from the first interface among the plurality of interfaces, receiving, at the terminal device, only some of the plurality of instructions which is capable of being received by the fixed reception device.

15. A substrate processing system comprising:
a substrate processing apparatus including a plurality of modules; and
a terminal device,
wherein the substrate processing apparatus includes a plurality of interfaces arranged in a distributed manner, and
wherein, when being connected to a first interface of the plurality of interfaces, the terminal device is configured to:
display modules which are capable of being instructed to operate by the terminal device, among the plurality of modules, according to the first interface to which the terminal device is connected;
receive a selection of a module to be subjected to a maintenance among the modules displayed on the terminal device; and
output a maintenance instruction relating to the maintenance on the selected module.

16. A non-transitory computer-readable recording medium storing a program that causes a terminal device to execute a process,
the process including:
when the terminal device is connected to a first interface of a plurality of interfaces dispersedly arranged in a substrate processing apparatus including a plurality of modules, displaying, on the terminal device, modules which are capable of being instructed to operate by the terminal device, among the plurality of modules, according to the first interface to which the terminal device is connected;
selecting a module to be subjected to a maintenance among the modules displayed on the terminal device, and receiving, at the terminal device, the selection of the module to be subjected to the maintenance among the modules displayed on the terminal device; and
outputting a maintenance instruction relating to the maintenance on the selected module.
